(19) United States
(12) Patent Application Publication
(10) Pub. No.: US 2026/0035964 A1
(43) Pub. Date: Feb. 5, 2026

(54) A LOCKING MECHANISM AND A SHEET-LIKE DOOR RAILING THEREWITH

(71) Applicant: Guangzhou Fengshine Metal Products Co.,Ltd, Guangzhou (CN)

(72) Inventor: LONGCHUN LIU, Guangzhou (CN)

(21) Appl. No.: 18/884,245

(22) Filed: Sep. 13, 2024

(30) Foreign Application Priority Data
Aug. 2, 2024 (CN) 202421866654.8

(51) Int. Cl. E05B 65/00; E06B 9/00; E06B 11/02

(52) U.S. Cl. CPC E05B 65/0007; E05B 65/0014; E06B 11/02; E06B 2009/002

(57) ABSTRACT

The present invention discloses a locking mechanism and a sheet-like door railing therewith and, compared with the traditional one, the present invention, based on the prior art, through the fitted connection between the hook portion and hook groove, ensures that the outer door railing remains fitted connection with the locking mechanism, without local reset, when the zip tie or rope at the corresponding position is cut, thereby avoiding possible body injury caused by reset.

### CROSS-REFERENCE TO RELATED APPLICATIONS

This application claims priority to Chinese Patent Application No. 202421866654.8, filed on Aug. 2, 2024, which is hereby incorporated by reference in its entirety.

### TECHNICAL FIELD

The present invention relates to the technical field of protective door railing, particularly to a locking mechanism and a sheet-like door railing therewith.

### BACKGROUND

With the social economic progress, people have also increased their awareness of safety, especially for children, and not only attach importance to children safety outdoors, but also to children safety indoors. Therefore, parents usually provide safety door railings in indoor corridors, stairwells and other locations to eliminate potential dangers.

The safety door railings for children or pets currently available in the market generally consist of two parts: an outer door railing and an inner door railing. The outer door railing is fixed in the installation position, mainly consisting of a horizontal bottom pole, and two vertical posts fixed at both ends of the bottom pole; the inner door railing is located between the two vertical posts, with one side being rotatably connected to one of the vertical posts, and the other side being provided with a door railing lock; a lock groove that fits the door railing lock is provided on the other vertical post, and the fit between door railing lock and lock groove allows to lock the outer door railing and inner door railing.

In the prior art, the outer door railing is mainly fixed through tight contact with various locations at the installation position and, however, since the vertical post is in a vertical state, the vertical post with a lock groove is forced to tilt by the force generated by the tight contact, so that the lock groove which is too close to the door railing lock exceeds the position where the lock groove fits the door railing locking tab, resulting in the mismatch between the inner door railing and outer door railing; in order to avoid such mismatch, the vertical post having a lock groove is usually set to be slightly tilted, so that the upper end of vertical post is slightly away from the door railing lock, and after assembly is completed, the vertical post is slightly deformed against the compression of installation position and is then position corrected; door lock causes the upper end of vertical post to move in the direction of door lock, so that the lock groove reaches the position where it fits the door lock, meanwhile elastic contact is maintained between the upper end of vertical post and the installation position, thereby improving the fixing strength to a certain degree.

At the time of product delivery from the factory, in order to facilitate the packaging of the product and the assembly with the installation position, the vertical post having a lock groove is tied to the inner door railing at an appropriate position by zip ties or ropes when the lock groove is in a position that fits the door railing lock, so that the vertical post remains deformed and the lock groove remains in a position that fits the door railing lock; the zip ties or ropes can be cut off after the assembly with the installation position, and therefore, special instructions are provided in the installation steps of the product manual.

There are also some shortcomings: sometimes consumers may unknowingly take the product out of the packaging box and directly cut off the zip ties or ropes, at the moment when the zip ties or ropes break, a part of the outer door railing, that is, one of the vertical posts, will reset after being released from the deformation state, making the lock groove far away from the door railing lock, and the fast and short reset process, which is accompanied with large instantaneous abrupt force, is more likely to cause body injury when it comes into contact with the human body.

### SUMMARY

The main purpose of the invention is to propose a locking mechanism and a sheet-like door railing therewith, aiming to address the problem of body injury during the local reset process due to the breakage of ties or ropes on the existing safety door railing.

To achieve the above purpose, the present invention proposes a locking mechanism, comprising a first connecting seat, and a locking tab provided thereon, and the outer wall of the first connecting seat is provided with a hook portion.

Preferably, the locking tab is movably disposed inside the first connecting seat and moves relative to the first connecting seat between the position where it partially extends the first connecting seat and the position where it retracts into the first connecting seat, the locking tab is connected to a drive portion located outside the first connecting seat, the drive portion is used to drive the locking tab to move, a limit piece is also provided and is movably installed on the first connecting seat, the limit piece moves relative to the first connecting seat between the position where it is partially opposite to the locking tab and the position where it is offset from the locking tab, and when the limit piece is partially opposite to the locking tab, it limits the locking tab to retract towards the interior of the first connecting seat.

Preferably, the first connecting seat is provided with a first chamber for accommodating the locking tab, and a ferrule is movably installed in the first chamber and is sleeved on the locking tab, and the front and rear sides of the first connecting seat are provided with a drive portion that is fixedly connected to the ferrule.

Preferably, the ferrule is movably disposed on the locking tab, and the locking tab moves relative to the ferrule between the position where it partially passes through the ferrule and exposed outside and the position where it retracts inside the ferrule, a first top spring is also provided, one end of the first top spring is pressed against the inner wall of the first chamber, and the other end is in elastic contact with the locking tab to apply elastic force to make the locking tab move in the direction where the locking tab partially passes through the ferrule and is exposed outside.

Preferably, the drive portion is fixed to the ferrule through a connecting portion, and the first connecting seat is open to form avoidance at the position corresponding to the movement trajectory of the connecting portion.

Preferably, the bottom wall of the ferrule is provided with a first limit portion, the first chamber is provided with a first limit hole, and the first limit portion partially extends into the first limit hole and moves within the first limit hole along with the movement of the ferrule.

Preferably, the outer wall of the drive portion is provided with anti slip patterns.

Preferably, the first connecting seat is provided with a second chamber to accommodate the limit piece, one side of the first chamber is provided with a vertically extending locating hole, the first chamber is connected to the second chamber through the locating hole, and one end of the limit piece is rotatably installed in the second chamber to allow the limit piece to swing vertically relative to the first connecting piece, and the other end of the limit piece is provided with a locating portion that extends into the first chamber through the locating hole and moves, along with the vertical swing of limit piece, between the position where it is opposite to the locking tab and the position where it is offset from the locking tab.

Preferably, the ferrule is provided with a slot for inserting the locating portion, and the locating portion moves, along with the vertical swing of limit piece, between the position where it is opposite to the outer wall of the ferrule and the position where it is opposite to the slot.

Preferably, the second chamber is provided with a connecting pin, and the free end wall of connecting pin is a cambered surface, the end of limit piece away from the locating portion is provided with a pivot groove for running fit with the free end of the connecting pin, a cover body is additionally provided at the position on the second chamber corresponding to the lower part of the pivot groove.

The present invention also proposes a sheet-like door railing, comprising an outer door railing, an inner door railing rotatably mounted on the outer door railing, and a locking mechanism as described in the above embodiment, the locking mechanism is mounted on the inner door railing, the outer door railing is provided with a lock groove that fits the locking tab, the inner door railing swings relative to the outer door railing between the position where the locking tab is aligned with the lock groove and the position where the locking tab is offset from the lock groove, and the outer door railing is further provided with a hook groove that fits the hook portion, and the hook portion swings, along with the swing of the inner door railing, between the position where it enters the hook groove and the position where it exits the hook groove.

Preferably, the lock groove is directly formed on the outer door railing, or is provided with a second connecting seat having the lock groove, and the second connecting seat is installed on the outer door railing.

Preferably, a moving block is movably installed inside the lock groove and moves between the position where it is flush with the opening of lock groove and the position where it is far away from the opening of lock groove, a second top spring is additionally provided to apply elastic force to make the moving block move in the direction in which the moving block is flush with the opening of lock groove.

Preferably, the lock groove is provided with a second limit hole, and the side of the moving block away from the opening of lock groove is provided with a second limit portion passing through the second limit hole, the end of the second limit portion away from the moving block has a hook to prevent the moving block from disengaging from the lock groove.

Preferably, a movable pin is installed at the bottom of the inner door railing corresponding to the locking mechanism, and a lock hole is provided at the position of the outer door railing corresponding to the lower part of movable pin, the movable pin is linked with the limit piece through a pulling rope, and moves with the movement of the limit piece between the position where it inserts lock hole and the position where it exits lock hole.

Preferably, the inner door railing is rotatably connected to the outer door railing through a first hinge structure and a second hinge structure, the first hinge structure comprises a seat body fixed to the outer door railing and a first swinging member fixed to the inner door railing, the first swinging member is provided with a vertically extending connecting shaft, and the seat body is provided with a vertically extending shaft hole that is open at both ends, the connecting shaft is inserted into the shaft hole from top to bottom to achieve running fit between first swinging member and the seat body, the free end of the connecting shaft is provided with a stop end to restrict the connecting shaft from disengaging from the shaft hole from bottom to top, and the upper end of shaft hole is provided with a guide groove, a guide portion for contacting the guide groove is provided at a position of the first swinging member corresponding to the upper part of guide groove, and the first swinging member, when swinging along with the inner door railing in the direction away from the locking tab and lock groove, moves upward relative to the seat body through the fit between the guide portion and the guide groove;

the second hinge structure comprises a second swinging member fixed to the inner door railing and a pin inserted into the outer door railing, the pin is rotably inserted into the second swinging member, the upper end of the pin is provided with a locking position, and the second swinging member is provided with a locking block that fits the locking position, the locking block moves, along with the swinging of inner door railing, between the position where it enters the slot and the position where it leaves away from the slot, and the locking block is located in the slot when the locking tab is aligned with the lock groove.

Preferably, the outer door railing is fixed to the installation position by a fixing mechanism, the fixing mechanism comprises a retaining member that is rotatably connected to the outer door railing and moves relative to the outer door railing between the position where it is tightly against the installation position and the position where it is separated from the installation position, the retaining member is also rotatably connected to a locking member that moves relative to the retaining member between the position where the locking member is tightly against outer door railingto lock the retaining member and the position where the locking member is separated from the retaining member; a plurality of limit portions are provided at circular intervals on one side of the locking member near the outer door railing, a recess is formed at the position of the outer door railing corresponding to the limit portion, and the limit portion is located in the recess when the locking member is tightly pressed against the outer door railing.

Preferably, the outer door railing comprises a horizontal post, and two vertical posts fixed at both ends of the horizontal post, and the inner door railing (3) is located at a position between two vertical posts above the horizontal post, the inner door railing is a frame shaped component formed by a plurality of connected posts or by a sheet shaped component having a plurality of hollow openings, and in case of frame shaped component, the inner door railing is covered by a soft item.

The technical solution of the present invention provides a lock groove and a hook groove for the outer door railing, the inner door railing is provided with a locking mechanism comprising a first connecting seat and a locking tab provided thereon, and the outer wall of the first connecting seat is provided with a hook portion that fits the hook groove, the inner door railing can swing relative to the outer door railing to open or close the door, the hook portion can, with the swing of the inner door railing, swing between the position where it is connected to the hook groove and the position where it is away from the hook groove and, when the lock groove is aligned with the locking tab of the locking mechanism, the hook portion and hook groove are connected and engaged, the locking tab can extend into the lock groove to lock the inner and outer door railing, and keep the locking mechanism connected to the outer door railing through the connection and engagement between the hook portion and hook groove, and, compared with the traditional one, the present invention, based on the prior art, through the fitted connection between the hook portion and hook groove, ensures that the outer door railing remains fitted connection with the locking mechanism, without local reset, when the zip tie or rope at the corresponding position is cut, thereby avoiding possible body injury caused by reset.

### BRIEF DESCRIPTION OF DRAWINGS

FIG. 1 is a stereogram of the locking mechanism;

FIG. 2 is a sectional view of the locking mechanism;

FIG. 3 is an exploded view of the locking mechanism from the first angle;

FIG. 4 is an exploded view of the locking mechanism from the second angle;

FIG. 5 is a stereogram of a sheet-like door railing;

FIG. 6 is a schematic diagram of the outer door railing and inner door railing;

FIG. 7 is a sectional view of a sheet-like door railing;

FIG. 8 is a sectional view of the locking tab that is partially inserted into the lock groove;

FIG. 9 is an assembly sectional view of the first swinging member and the seat body.

### DETAILED DESCRIPTION OF THE EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be noted that all directional indicators (such as up, down, left, right, front, back, top, bottom, inside, outside, vertical, horizontal, vertical, counterclockwise, clockwise, circumferential, radial, axial . . . ) in the embodiments of the present invention are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present invention are only for illustrative purposes and cannot be understood as indicating or implying relative importance or the number of features referred to. Therefore, the features defined with “first” and “second” may explicitly or implicitly include at least one or a plurality of the features. At the same time, the technical solutions of various embodiments can be combined with each other, but must be based on what those of ordinary skill in the art can achieve. The combination of technical solutions that result in contradiction or make it impossible to implement should be considered non-existent, and accordingly should not fall within the scope of protection required by this present invention.

The present invention proposes a locking mechanism.

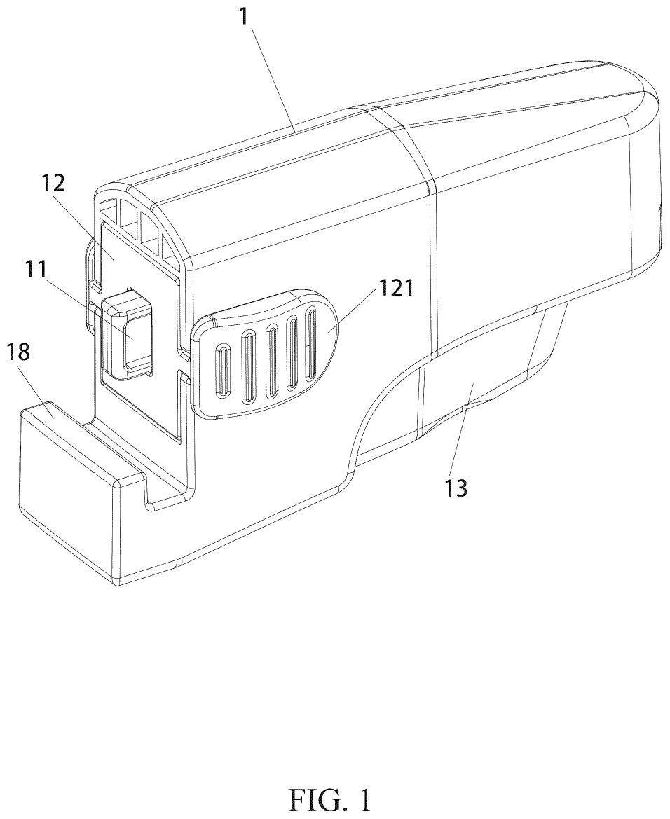

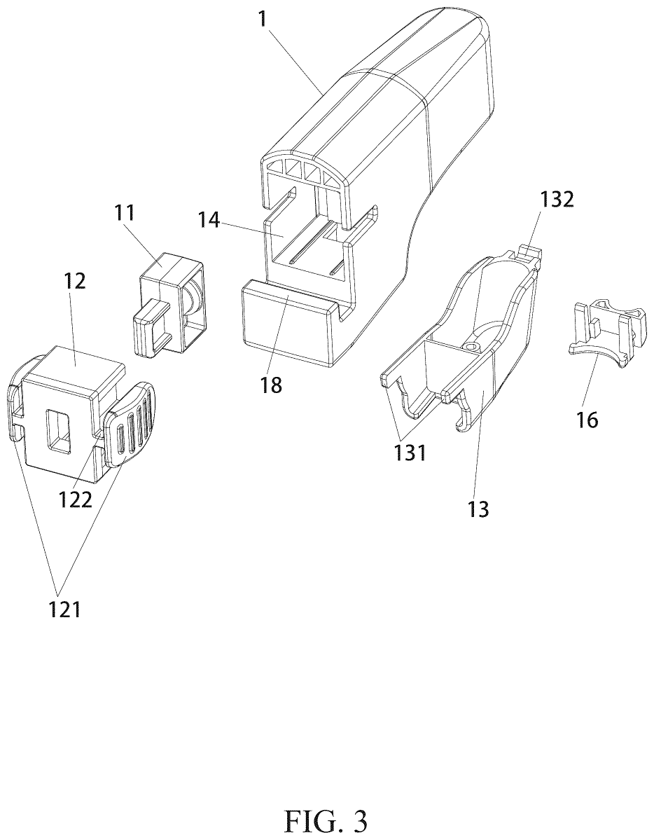

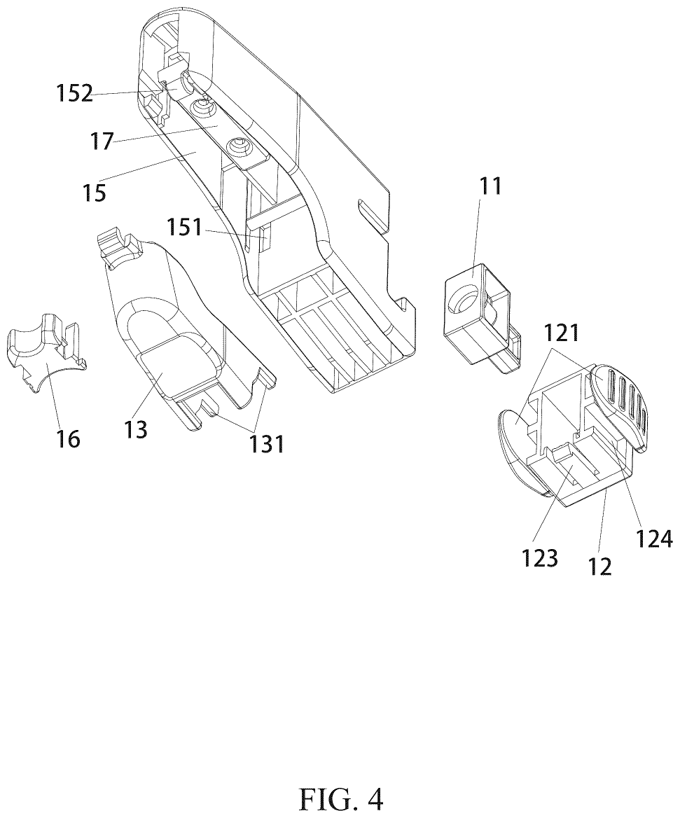

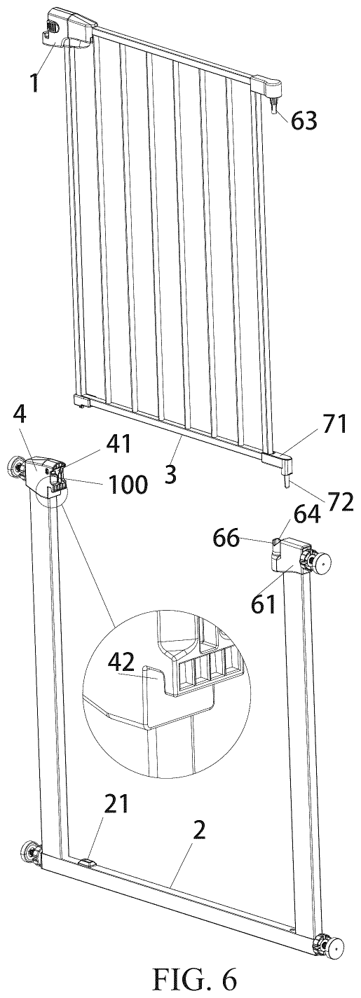

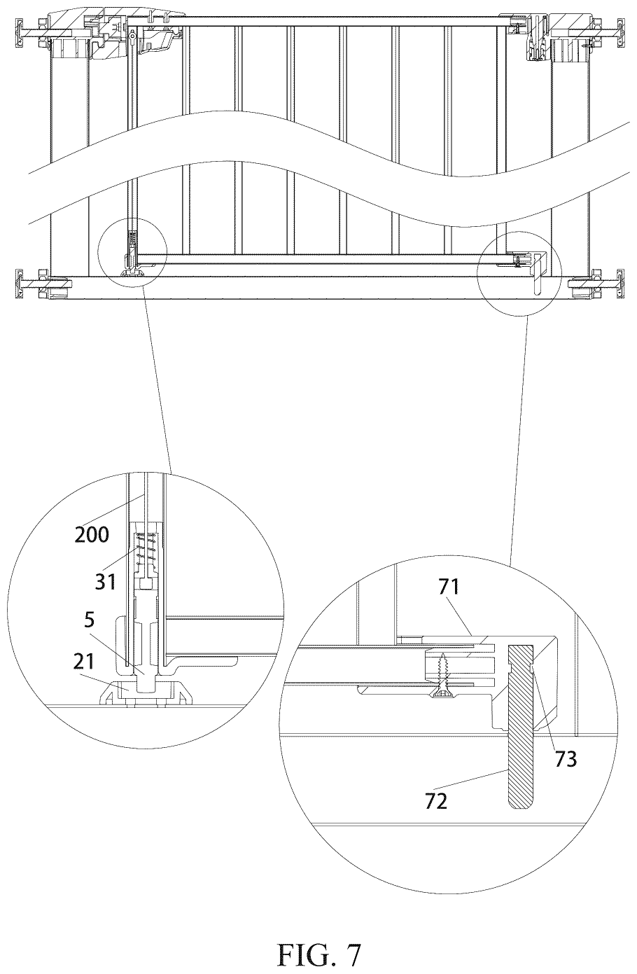

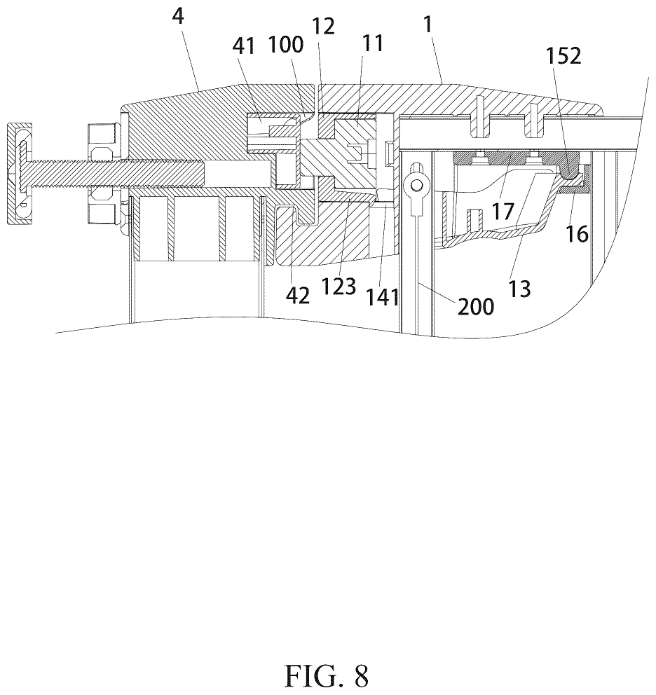

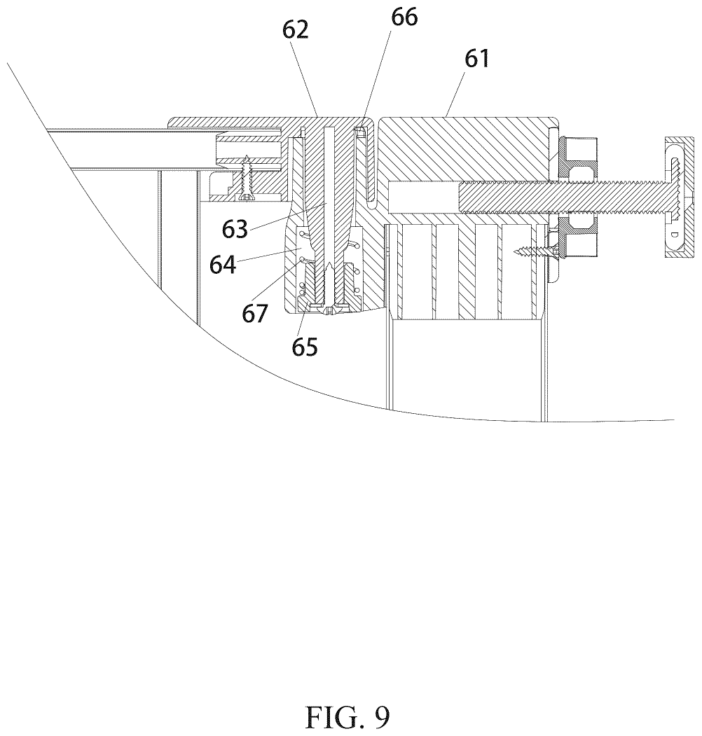

In the embodiment of the present invention, as shown in FIGS. 1 to 9, the locking mechanism comprises a first connecting seat 1, and a locking tab 11 provided thereon, and the outer wall of the first connecting seat is provided with a hook portion 18.

Specifically, the locking tab 11 is movably disposed inside the first connecting seat 1 and moves relative to the first connecting seat 1 between the position where it partially extends the first connecting seat 1 and the position where it retracts into the first connecting seat 1, the locking tab 11 is connected to a drive portion 121 located outside the first connecting seat 1, the drive portion 121 is used to drive the locking tab 11 to move, a limit piece 13 is also provided and is movably installed on the first connecting seat 1, the limit piece 13 moves relative to the first connecting seat 1 between the position where it is partially opposite to the locking tab 11 and the position where it is offset from the locking tab 11, and when the limit piece 13 is partially opposite to the locking tab 11, it limits the locking tab 11 to retract towards the interior of the first connecting seat 1. Hold the first connecting seat with your palm, and drive the limit piece to move using your middle finger, ring finger, and little finger until it is partially offset from the locking tab, then clamp the drive portion with your thumb and index finger and apply force to drive the locking tab to move towards the direction in which it will exits the lock groove. Compared with traditional methods, the unlocking action, which is completed in two steps, increases the difficulty of unlocking for children and is not easy to learn, and effectively addresses the problem of easy unlocking by the children. For adults, the unlocking action conforms to ergonomics and can be easily realized with one hand.

Specifically, the first connecting seat 1 is provided with a first chamber 14 for accommodating the locking tab 11, and a ferrule 12 is movably installed in the first chamber 14 and is sleeved on the locking tab 11, and the front and rear sides of the first connecting seat 1 are provided with a drive portion 121 that is fixedly connected to the ferrule 12. The drive portion 121 drives the ferrule 12 to partially extend or retract the locking tab 11 from the first connecting seat 1.

Specifically, the ferrule 12 is movably disposed on the locking tab 11, and the locking tab 11 moves relative to the ferrule 12 between the position where it partially passes through the ferrule 12 and exposed outside and the position where it retracts inside the ferrule 12, a first top spring is also provided, one end of the first top spring is pressed against the inner wall of the first chamber 14, and the other end is in elastic contact with the locking tab 11 to apply elastic force to make the locking tab 11 move in the direction where the locking tab 11 partially passes through the ferrule 12 and is exposed outside. The exposed part of the locking tab 11 passing through the ferrule 12 is the part where the locking tab 11 extends out of the first connecting seat 1.

Specifically, due to the fact that the ferrule 12 is located inside the first connecting seat 1, while the drive portion 121 is located outside the first connecting seat 1 and fixedly connected to the ferrule 12, and in order to ensure that the drive portion 121 can smoothly drive the movement of ferrule 12, the drive portion 121 in this embodiment is fixed to the ferrule 12 through a connecting portion 122, and the first connecting seat 1 is open to form avoidance at the position corresponding to the movement trajectory of the connecting portion 122.

Specifically, the bottom wall of the ferrule 12 is provided with a first limit portion 123, the first chamber 14 is provided with a first limit hole 141, and the first limit portion 123 partially extends into the first limit hole 141 and moves within the first limit hole 141 along with the movement of the ferrule 12.

Specifically, the outer wall of the drive portion 121 is provided with anti slip patterns.

Specifically, the first connecting seat 1 is provided with a second chamber 15 to accommodate the limit piece 13, one side of the first chamber 14 is provided with a vertically extending locating hole 151, the first chamber 14 is connected to the second chamber 15 through the locating hole 151, and one end of the limit piece 13 is rotatably installed in the second chamber 15 to allow the limit piece 13 to swing vertically relative to the first connecting piece, and the other end of the limit piece 13 is provided with a locating portion 131 that extends into the first chamber 14 through the locating hole 151 and moves, along with the vertical swing of limit piece 13, between the position where it is opposite to the locking tab 11 and the position where it is offset from the locking tab 11.

Specifically, the ferrule 12 is provided with a slot 124 for inserting the locating portion 131, and the locating portion 131 moves, along with the vertical swing of limit piece 13, between the position where it is opposite to the outer wall of the ferrule 12 and the position where it is opposite to the slot 124. When the locating portion 131 is opposite to the slot 124, the locking tab 11 can move in the direction in which it partially retracts into the first connecting seat 1 while making the locating portion 131 to be inserted into the slot 124.

Specifically, the second chamber 15 is provided with a connecting pin 152, and the free end wall of connecting pin 152 is a cambered surface, the end of limit piece 13 away from the locating portion 131 is provided with a pivot groove 132 for running fit with the free end of the connecting pin 152, a cover body 16 is additionally provided at the position on the second chamber 15 corresponding to the lower part of the pivot groove 132. The cover body 16 is used to prevent the pivot groove 132 from disengaging from the connecting pin 152 and is locked by screws or fixed to the second chamber 15 through a buckle structure and, in case of a buckle structure, reference can be made to the prior art, and its specific structural principle is not elaborated here.

The present invention also proposes a sheet-like door railing, comprising an outer door railing 2, an inner door railing 3 rotatably mounted on the outer door railing 2, and a locking mechanism as described in the above embodiment, and since all technical solutions of all embodiments of the above-mentioned locking mechanism is used, the sheet-like door railing has at least all the beneficial effects brought by the technical solutions of the above embodiments, which will not be elaborated here. The locking mechanism is mounted on the inner door railing 3, the outer door railing 2 is provided with a lock groove 100 that fits the locking tab, the inner door railing 3 swings relative to the outer door railing 2 between the position where the locking tab 11 is aligned with the lock groove 100 and the position where the locking tab 11 is offset from the lock groove 100, and the outer door railing is further provided with a hook groove 42 that fits the hook portion 18, and the hook portion 18 swings, along with the swing of the inner door railing, between the position where it enters the hook groove 42 and the position where it exits the hook groove 42.

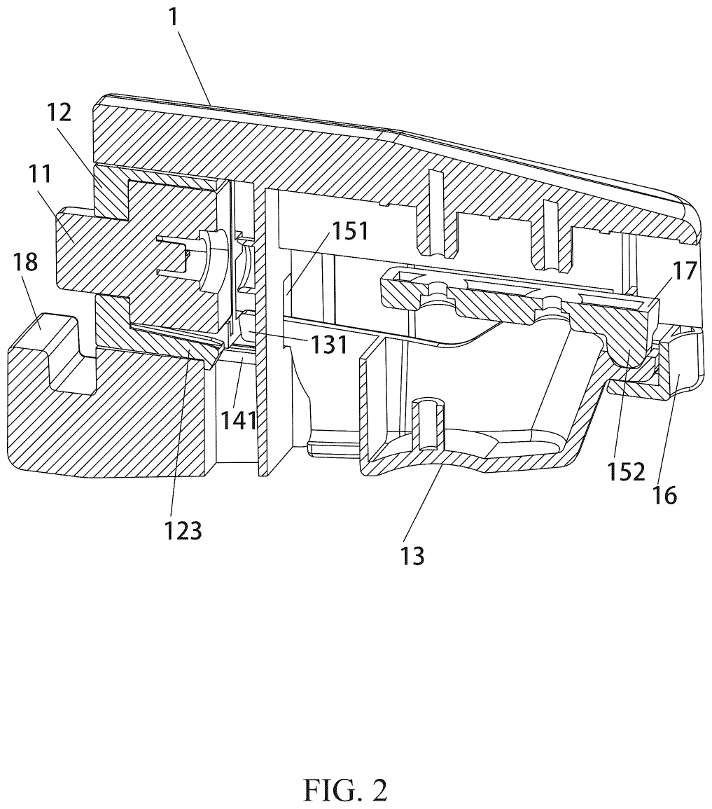

Specifically, when the first connecting seat 1 is assembled on the inner door railing 3, the connecting pin 152 can directly pass through the inner door railing 3 and rotate with the pivot groove 132, or as shown in FIGS. 2, 4, and 8, the second chamber 15 is also provided with a strip component 17 having connecting pin 152, the strip component 17 is locked to the inner door railing 3 by screws, the first connecting seat 1 wraps a part of inner door railing 3, and the strip component 17 through the second chamber 15, and then the limit piece 13 and cover body 16 are sequentially assembled to complete the detachable assembly of the locking mechanism and inner door railing 3.

Specifically, the lock groove 100 is directly formed on the outer door railing 2, or is provided with a second connecting seat 4 having the lock groove 100, and the second connecting seat 4 is installed on the outer door railing 2, and the hook groove is formed on the second connecting seat 4.

Specifically, the hook portion 18 has various shapes, may be L-shaped, C-shaped, or other shapes that can prevent separation between the second connecting seat and the first connecting seat.

It should be noted that the direction of motion when the first connecting seat separates from the second connecting seat is the same as that when the locking tab extends or retracts.

Specifically, the hook groove has opposite sides that extend through the front and rear walls of the first connecting seat, so that hook portion can smoothly enter hook groove during the swinging process to connect with the hook groove or smoothly exit the hook groove to release the connection.

Specifically, the second connecting seat 4 is provided with a guide surface at a position corresponding to the lock groove 100, and during the swinging process of the inner door railing 3 towards the alignment direction of locking tab 11 and lock groove 100, the guide surface forces locking tab 11 to move back into the first connecting seat 1 until the locking tab 11 corresponds to the lock groove 100, and the elastic force applied by the first top spring forces locking tab 11 to partially extend from the first connecting seat 1 and insert into the lock groove 100, automatically locking the inner door railing 3 and outer door railing 2.

Specifically, a moving block 41 is movably installed inside the lock groove 100 and moves between the position where it is flush with the opening of lock groove 100 and the position where it is far away from the opening of lock groove 100, a second top spring is additionally provided to apply elastic force to make the moving block 41 move in the direction in which the moving block 41 is flush with the opening of lock groove 100.

It should be noted that the elastic force applied by the first top spring is greater than the elastic force applied by the second top spring, so as to push the moving block 41 away from the opening of lock groove 100 when the locking tab 11 is inserted into the lock groove 100.

Specifically, the second connecting seat 4 is also provided with a window connected to the lock groove 100, one side of the moving block 41 close to the window is provided with a first schematic part indicating the locked state and a second schematic part indicating the unlocked state, and when the moving block 41 is in a position flush with the opening of lock groove 100, the second schematic part aligns with the window, and when the moving block 41 is in a position far away from the opening of lock groove 100, the first schematic part aligns with the window.

Specifically, the lock groove 100 is provided with a second limit hole (not shown in the figure), and the side of the moving block 41 away from the opening of lock groove 100 is provided with a second limit portion (not shown in the figure) passing through the second limit hole, the end of the second limit portion away from the moving block 41 has a hook to prevent the moving block 41 from disengaging from the lock groove 100.

Specifically, the lock groove 100 is T-shaped, and the shape of moving block 41 fits the shape of lock groove 100.

Specifically, a movable pin 5 is installed at the bottom of the inner door railing 3 corresponding to the locking mechanism, and a lock hole 21 is provided at the position of the outer door railing 2 corresponding to the lower part of movable pin 5, the movable pin 5 is linked with the limit piece 13 through a pulling rope 200, and moves with the movement of the limit piece 13 between the position where it inserts lock hole 21 and the position where it exits lock hole 21. The fit between the moving pin 5 and lock hole 21 further locks the inner door railing 3 and outer door railing 2 and, when the limit piece 13 is partially opposite to the locking tab 11, the movable pin 5 is located in the lock hole 21, and when the limit piece 13 moves in the direction opposite to the locking tab 11, the movable pin 5 moves in the direction in which it exits the lock hole 21.

Specifically, a third top spring 31 is also provided to apply elastic force to make movable pin 5 move towards the direction in which it inserts into the lock hole 21.

Specifically, the outer door railing 2 is directly provided with a lock hole 21, or is provided with a connecting component having the lock hole 21 that can be locked with screws or fixed to the outer door railing 2 through a buckle structure.

Specifically, the inner door railing 3 is rotatably connected to the outer door railing 2 through a first hinge structure and a second hinge structure, the first hinge structure comprises a seat body 61 fixed to the outer door railing 2 and a first swinging member 62 fixed to the inner door railing 3, the first swinging member 62 is provided with a vertically extending connecting shaft 63, and the seat body 61 is provided with a vertically extending shaft hole 64 that is open at both ends, the connecting shaft 63 is inserted into the shaft hole 64 from top to bottom to achieve running fit between first swinging member 62 and seat body 61, the free end of the connecting shaft 63 is provided with a stop end 65 to restrict the connecting shaft 63 from disengaging from the shaft hole 64 from bottom to top, and the upper end of shaft hole 64 is provided with a guide groove 66, and a guide portion (not shown in the figure) for contacting the guide groove 66 is provided at a position of the first swinging member 62 corresponding to the upper part of guide groove 66, and the first swinging member 62, when swinging along with the inner door railing 3 in the direction away from the locking tab 11 and lock groove 100, moves upward relative to the seat body 61 through the fit between the guide portion and the guide groove 66;
the second hinge structure comprises a second swinging member 71 fixed to the inner door railing 3 and a pin 72 inserted into the outer door railing 2, the pin 72 is rotably inserted into the second swinging member 71, the upper end of the pin 72 is provided with a locking position, and the second swinging member 71 is provided with a locking block 73 that fits the locking position, the locking block 73 moves, along with the swinging of inner door railing 3, between the position where it enters the slot and the position where it leaves away from the slot, and the locking block 73 is located in the slot when the locking tab 11 is aligned with the lock groove 100.

Specifically, a fourth top spring 67 is sleeved on the connecting shaft 63, and the upper and lower ends of the fourth top spring 67 are respectively elastically opposed to the inner wall of shaft hole 64 and the stop end 65 and, when the inner door railing 3 swings towards the direction where the locking tab 11 is offset from the lock groove 100, the fourth top spring 67 is forced to compress, and when the inner door railing 3 swings towards the direction where the locking tab 11 aligns with the lock groove 100, the fourth top spring 67 gradually unlocks compression and releases elastic force, and the fit between guide portion and guide groove 66 makes inner door railing 3 automatically swing towards the direction where locking tab 11 aligns with lock groove 100, therefore the door is automatically closed.

Specifically, the outer door railing 2 is fixed to the installation position by a fixing mechanism, the fixing mechanism comprises a retaining member 81 that is rotatably connected to the outer door railing 2 and moves relative to the outer door railing 2 between the position where it is tightly against the installation position and the position where it is separated from the installation position, the retaining member 81 is also rotatably connected to a locking member 82 that moves relative to the retaining member 81 between the position where the locking member 82 is tightly against outer door railing 2 to lock the retaining member 81 and the position where the locking member 82 is separated from the retaining member 81; a plurality of limit portions (not shown in the figure) are provided at circular intervals on one side of the locking member 82 near the outer door railing 2, a recess (not shown in the figure) is formed at the position of the outer door railing 2 corresponding to the limit portion, and the limit portion is located in the recess when the locking member 82 is tightly pressed against the outer door railing 2.

It should be noted that the above-mentioned installation locations are mainly the walls.

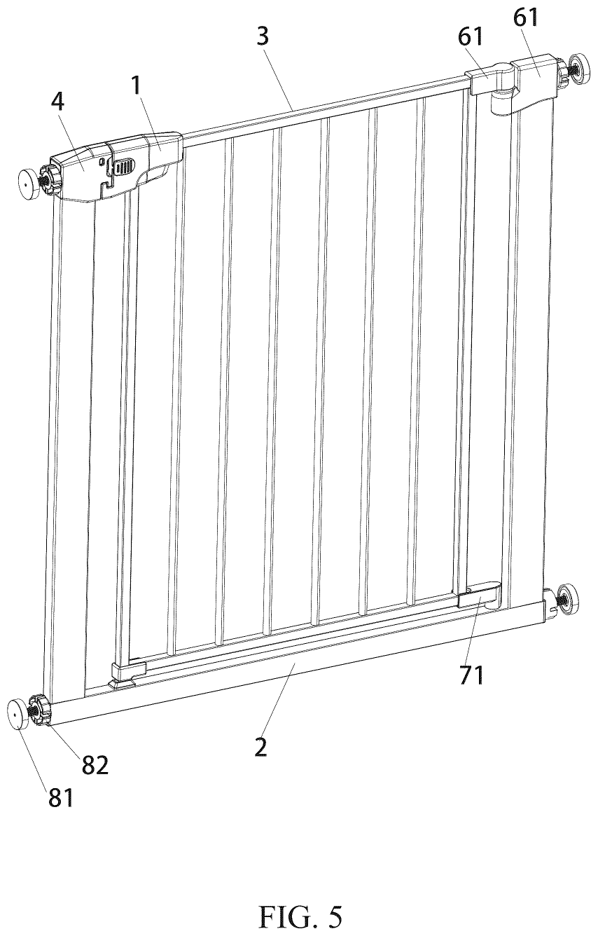

Specifically, in this embodiment, as shown in FIG. 5, the fixing mechanism is provided in the upper left corner, upper right corner, lower left corner, and lower right corner of the outer door railing 2.

Specifically, the outer door railing 2 comprises a horizontal post, and two vertical posts fixed at both ends of the horizontal post, and the inner door railing 3 is located at a position between two vertical posts above the horizontal post, the inner door railing 3 is a frame shaped component formed by a plurality of connected posts or by a sheet shaped component having a plurality of hollow openings, and in case of frame shaped component, the inner door railing 3 is covered by a soft item. Of course, the sheet-like component can also be covered by a soft item and in this embodiment, the vertical post having the second connecting seat is inclined relative to the horizontal post, and the vertical post can be forced to deform by external force to make the second connecting seat move towards the direction close to the locking mechanism, and the vertical post can be maintained at deformation state by the fit between hook portion and hook groove. When the sheet-like door railing is not assembled in the installation position, it is necessary to manually deform the vertical post to connect hook groove with hook portion and, after the sheet-like door railing is assembled and fixed in the installation position, the vertical post can be forced to maintain the deformation state by the installation position (mainly the wall), so that the lock groove is in the appropriate position.

Specifically, the inner door railing 3 can be a foldable structure or a non foldable structure and, in case of a foldable structure, the inner door railing 3 is folded through a joint mechanism for which reference can be made to the prior art, and the specific structural principle of the joint mechanism is not elaborated here.

The technical solution of the present invention provides a lock groove and a hook groove for the outer door railing, the inner door railing is provided with a locking mechanism comprising a first connecting seat and a locking tab provided thereon, and the outer wall of the first connecting seat is provided with a hook portion that fits the hook groove, the inner door railing can swing relative to the outer door railing to open or close the door, the hook portion can, with the swing of the inner door railing, swing between the position where it is connected to the hook groove and the position where it is away from the hook groove and, when the lock groove is aligned with the locking tab of the locking mechanism, the hook portion and hook groove are connected and engaged, the locking tab can extend into the lock groove to lock the inner and outer door railing, and keep the locking mechanism connected to the outer door railing through the connection and engagement between the hook portion and hook groove, and, compared with the traditional one, the present invention, based on the prior art, through the fitted connection between the hook portion and hook groove, ensures that the outer door railing remains fitted connection with the locking mechanism, without local reset, when the zip tie or rope at the corresponding position is cut, thereby avoiding possible body injury caused by reset.

The above are only the preferred embodiments of the present invention, and are not intended to limit the present invention. Any equivalent structural transformation made based on the description and accompanying drawings hereof under the concept of present invention, or be directly/indirectly applied in other related technical fields, should fall within scope of patent protection of the present invention.

1. A locking mechanism, comprising a first connecting seat (1) and a locking tab (11) provided thereon, wherein the outer wall of the first connecting seat is provided with a hook portion (18).

2. The locking mechanism according to claim 1, wherein the locking tab (11) is movably disposed inside the first connecting seat (1) and moves relative to the first connecting seat (1) between the position where it partially extends the first connecting seat (1) and the position where it retracts into the first connecting seat (1), the locking tab (11) is connected to a drive portion (121) located outside the first connecting seat (1), the drive portion (121) is used to drive the locking tab (11) to move, a limit piece (13) is also provided and is movably installed on the first connecting seat (1), the limit piece (13) moves relative to the first connecting seat (1) between the position where it is partially opposite to the locking tab (11) and the position where it is offset from the locking tab (11), and when the limit piece (13) is partially opposite to the locking tab (11), it limits the locking tab (11) to retract towards the interior of the first connecting seat (1).

3. The locking mechanism according to claim 2, wherein the first connecting seat (1) is provided with a first chamber (14) for accommodating the locking tab (11), and a ferrule (12) is movably installed in the first chamber (14) and is sleeved on the locking tab (11), and the front and rear sides of the first connecting seat (1) are provided with a drive portion (121) that is fixedly connected to the ferrule (12).

4. The locking mechanism according to claim 3, wherein the ferrule (12) is movably disposed on the locking tab (11), and the locking tab (11) moves relative to the ferrule (12) between the position where it partially passes through the ferrule (12) and exposed outside and the position where it retracts inside the ferrule (12), a first top spring is also provided, one end of the first top spring is pressed against the inner wall of the first chamber (14), and the other end is in elastic contact with the locking tab (11) to apply elastic force to make the locking tab (11) move in the direction where the locking tab (11) partially passes through the ferrule (12) and is exposed outside.

5. The locking mechanism according to claim 3, wherein the drive portion (121) is fixed to the ferrule (12) through a connecting portion (122), and the first connecting seat (1) is open to form avoidance at the position corresponding to the movement trajectory of the connecting portion (122).

6. The locking mechanism according to claim 3, wherein the bottom wall of the ferrule (12) is provided with a first limit portion (123), the first chamber (14) is provided with a first limit hole (141), and the first limit portion (123) partially extends into the first limit hole (141) and moves within the first limit hole (141) along with the movement of the ferrule (12).

7. The locking mechanism according to claim 2, wherein the outer wall of the drive portion (121) is provided with anti slip patterns.

8. The locking mechanism according to claim 3, wherein the first connecting seat (1) is provided with a second chamber (15) to accommodate the limit piece (13), one side of the first chamber (14) is provided with a vertically extending locating hole (151), the first chamber (14) is connected to the second chamber (15) through the locating hole (151), and one end of the limit piece (13) is rotatably installed in the second chamber (15) to allow the limit piece (13) to swing vertically relative to the first connecting piece, and the other end of the limit piece (13) is provided with a locating portion (131) that extends into the first chamber (14) through the locating hole (151) and moves, along with the vertical swing of limit piece (13), between the position where it is opposite to the locking tab (11) and the position where it is offset from the locking tab (11).

9. The locking mechanism according to claim 8, wherein the ferrule (12) is provided with a slot (124) for inserting the locating portion (131), and the locating portion (131) moves, along with the vertical swing of limit piece (13), between the position where it is opposite to the outer wall of the ferrule (12) and the position where it is opposite to the slot (124).

10. The locking mechanism according to claim 8, wherein the second chamber (15) is provided with a connecting pin (152), and the free end wall of connecting pin (152) is a cambered surface, the end of limit piece (13) away from the locating portion (131) is provided with a pivot groove (132) for running fit with the free end of the connecting pin (152), a cover body (16) is additionally provided at the position on the second chamber (15) corresponding to the lower part of the pivot groove (132).

11. A sheet-like door railing comprises an outer door railing (2), and an inner door railing (3) rotatably mounted on the outer door railing (2), wherein the sheet-like door railing further comprises a locking mechanism according to claim 1, the locking mechanism is mounted on the inner door railing (3), the outer door railing (2) is provided with a lock groove (100) that fits the locking tab, the inner door railing (3) swings relative to the outer door railing (2) between the position where the locking tab (11) is aligned with the lock groove (100) and the position where the locking tab (11) is offset from the lock groove (100), and the outer door railing is further provided with a hook groove (42) that fits the hook portion (18), and the hook portion (18) swings, along with the swing of the inner door railing, between the position where it enters the hook groove (42) and the position where it exits the hook groove (42).

12. The sheet-like door railing according to claim 11, wherein the lock groove (100) is directly formed on the outer door railing (2), or is provided with a second connecting seat (4) having the lock groove (100), and the second connecting seat (4) is installed on the outer door railing (2).

13. The sheet-like door railing according to claim 11, wherein a moving block (41) is movably installed inside the lock groove (100) and moves between the position where it is flush with the opening of lock groove (100) and the position where it is far away from the opening of lock groove (100), a second top spring is additionally provided to apply elastic force to make the moving block (41) move in the direction in which the moving block (41) is flush with the opening of lock groove (100).

14. The sheet-like door railing according to claim 13, wherein the lock groove (100) is provided with a second limit hole, and the side of the moving block (41) away from the opening of lock groove (100) is provided with a second limit portion passing through the second limit hole, the end of the second limit portion away from the moving block (41) has a hook to prevent the moving block (41) from disengaging from the lock groove (100).

15. The sheet-like door railing according to claim 11, wherein a movable pin (5) is installed at the bottom of the inner door railing (3) corresponding to the locking mechanism, and a lock hole (21) is provided at the position of the outer door railing (2) corresponding to the lower part of movable pin (5), the movable pin (5) is linked with the limit piece (13) through a pulling rope (200), and moves with the movement of the limit piece (13) between the position where it inserts lock hole (21) and the position where it exits lock hole (21).

16. The sheet-like door railing according to claim 11, wherein the inner door railing (3) is rotatably connected to the outer door railing (2) through a first hinge structure and a second hinge structure, the first hinge structure comprises a seat body (61) fixed to the outer door railing (2) and a first swinging member (62) fixed to the inner door railing (3), the first swinging member (62) is provided with a vertically extending connecting shaft (63), and the seat body (61) is provided with a vertically extending shaft hole (64) that is open at both ends, the connecting shaft (63) is inserted into the shaft hole (64) from top to bottom to achieve running fit between first swinging member (62) and the seat body (61), the free end of the connecting shaft (63) is provided with a stop end (65) to restrict the connecting shaft (63) from disengaging from the shaft hole (64) from bottom to top, and the upper end of shaft hole (64) is provided with a guide groove (66), a guide portion for contacting the guide groove (66) is provided at a position of the first swinging member (62) corresponding to the upper part of guide groove (66), and the first swinging member (62), when swinging along with the inner door railing (3) in the direction away from the locking tab (11) and lock groove (100), moves upward relative to the seat body (61) through the fit between the guide portion and the guide groove (66);
the second hinge structure comprises a second swinging member (71) fixed to the inner door railing (3) and a pin (72) inserted into the outer door railing (2), the pin (72) is rotably inserted into the second swinging member (71), the upper end of the pin (72) is provided with a locking position, and the second swinging member (71) is provided with a locking block (73) that fits the locking position, the locking block (73) moves, along with the swinging of inner door railing (3), between the position where it enters the slot and the position where it leaves away from the slot, and the locking block (73) is located in the slot when the locking tab (11) is aligned with the lock groove (100).

17. The sheet-like door railing according to claim 11, wherein the outer door railing (2) is fixed to the installation position by a fixing mechanism, the fixing mechanism comprises a retaining member (81) that is rotatably connected to the outer door railing (2) and moves relative to the outer door railing (2) between the position where it is tightly against the installation position and the position where it is separated from the installation position, the retaining member (81) is also rotatably connected to a locking member (82) that moves relative to the retaining member (81) between the position where the locking member (82) is tightly against outer door railing (2) to lock the retaining member (81) and the position where the locking member (82) is separated from the retaining member (81); a plurality of limit portions are provided at circular intervals on one side of the locking member (82) near the outer door railing (2), a recess is formed at the position of the outer door railing (2) corresponding to the limit portion, and the limit portion is located in the recess when the locking member (82) is tightly pressed against the outer door railing (2).
The sheet shaped door railing according to claim 11, wherein the outer door railing (2) comprises a horizontal post, and two vertical posts fixed at both ends of the horizontal post, and the inner door railing (3) is located at a position between two vertical posts above the horizontal post, the inner door railing (3) is a frame shaped component formed by a plurality of connected posts or by a sheet shaped component having a plurality of hollow openings, and in case of frame shaped component, the inner door railing (3) is covered by a soft item.
